(19) United States
(12) Patent Application Publication
(10) Pub. No.: US 2020/0404157 A1
(43) Pub. Date: Dec. 24, 2020

(54) DISPLAY CONTROL DEVICE, CAMERA DEVICE, AND DISPLAY CONTROL METHOD

(71) Applicant: SZ DJI TECHNOLOGY CO., LTD., Shenzhen (CN)

(72) Inventors: Ming SHAO, Shenzhen (CN); Chihiro TSUKAMOTO, Shenzhen (CN); Hui XU, Shenzhen (CN)

(21) Appl. No.: 17/014,758

(22) Filed: Sep. 8, 2020

Related U.S. Application Data
(63) Continuation of application No. PCT/CN2019/078374, filed on Mar. 15, 2019.

(30) Foreign Application Priority Data
Mar. 22, 2018 (JP) 2018-055273

(51) Int. Cl. H04N 5/232; G06T 7/70; H04N 5/225

(52) U.S. Cl. CPC H04N 5/23212; H04N 5/232945; H04N 5/2257; G06T 7/70

(57) ABSTRACT

A display control device includes a processor and a computer-readable storage medium. The computer-readable storage medium stores a program that, when executed by the processor, causes the processor to determine a present lens position of a lens of a camera device, determine a target position of a target object being photographed by the camera device, and display a first indicator indicating the present lens position and a second indicator indicating the target position on a display in a position relationship corresponding to a relationship between the present lens position and the target position.

### CROSS-REFERENCE TO RELATED APPLICATIONS

This application is a continuation of International Application No. PCT/CN2019/078374, filed Mar. 15, 2019, which claims priority to Japanese Application No. 2018-055273, filed Mar. 22, 2018, the entire contents of both of which are incorporated herein by reference.

### TECHNICAL FIELD

The present disclosure relates to a display control device, a camera device, and a display control method and program.

### BACKGROUND

Japanese Patent Application Laid-Open No. 2007-256464 discloses a focus assist device. The focus assist device may display a degree of change in a focus adjustment state as a focus lens moves.

### SUMMARY

Embodiments of the present disclosure provide a display control device including a processor and a computer-readable storage medium. The computer-readable storage medium stores a program that, when executed by the processor, causes the processor to determine a present lens position of a lens of a camera device, determine a target position of a target object being photographed by the camera device, and display a first indicator indicating the present lens position and a second indicator indicating the target position on a display in a position relationship corresponding to a relationship between the present lens position and the target position.

Embodiments of the present disclosure provide a camera device including a focus lens, an image sensor, a display, and a display control device. The image sensor is configured to convert an optical image formed through the lens into an electrical signal. The display control device includes a processor and a computer-readable storage medium. The computer-readable storage medium stores a program that, when executed by the processor, causes the processor to determine a present lens position of a lens of a camera device, determine a target position of a target object being photographed by the camera device, and display a first indicator indicating the present lens position and a second indicator indicating the target position on a display in a position relationship corresponding to a relationship between the present lens position and the target position.

### BRIEF DESCRIPTION OF THE DRAWINGS

FIG. 1 is a schematic diagram showing functional blocks of a camera device according to some embodiments of the present disclosure.

FIG. 2 is a schematic diagram showing a curve of relationship between cost and a lens position according to some embodiments of the present disclosure.

FIG. 3 is a schematic flowchart showing a process of calculating a distance to an object based on the cost according to some embodiments of the present disclosure.

FIG. 4 is a schematic diagram showing the relationship among the object position, the lens position, and the focus distance according to some embodiments of the present disclosure.

FIG. 5 is a schematic diagram showing a display example of a first indicator and a second indicator according to some embodiments of the present disclosure.

FIG. 6 is a schematic diagram showing another display example of the first indicator and the second indicator according to some embodiments of the present disclosure.

FIG. 7 is a schematic diagram explaining reliability of a target position according to some embodiments of the present disclosure.

FIG. 8 is a schematic diagram showing another display example of the first indicator and the second indicator according to some embodiments of the present disclosure.

FIG. 9 is a schematic diagram showing another display example of the first indicator and the second indicator according to some embodiments of the present disclosure.

FIG. 10 is a schematic diagram showing another display example of the first indicator and the second indicator according to some embodiments of the present disclosure.

FIG. 11A is a schematic diagram showing another display example of the first indicator and the second indicator according to some embodiments of the present disclosure.

FIG. 11B is a schematic diagram showing another display example of the first indicator and the second indicator according to some embodiments of the present disclosure.

FIG. 11C is a schematic diagram showing another display example of the first indicator and the second indicator according to some embodiments of the present disclosure.

FIG. 12A is a schematic diagram showing another display example of the first indicator and the second indicator according to some embodiments of the present disclosure.

FIG. 12B is a schematic diagram showing another display example of the first indicator and the second indicator according to some embodiments of the present disclosure.

FIG. 12C is a schematic diagram showing another display example of the first indicator and the second indicator according to some embodiments of the present disclosure.

FIG. 13 is an exemplary schematic of a 3D outer appearance of the camera device according to some embodiments of the present disclosure.

FIG. 14 is an exemplary schematic of a rear view of the camera device according to some embodiments of the present disclosure.

FIG. 15 is an exemplary schematic of a display bar displayed on a viewfinder of the camera device according to some embodiments of the present disclosure.

FIG. 16 is an exemplary schematic of a display bar displayed on a display of a smartphone according to some embodiments of the present disclosure.

FIG. 17 is an exemplary structural schematic of hardware according to some embodiments of the present disclosure.

### REFERENCE NUMERALS

100 Camera device
102 Imaging unit
110 Camera controller
120 Image sensor
130 Target position determination circuit
132 Acquisition circuit
134 Computation circuit
136 Prediction circuit
140 Focus controller
142 Lens position determination circuit
144 Reliability determination circuit
150 Display controller
160 Display
162 Operation circuit
170 Storage device
200 Lens unit
210 Lens
212 Lens driver
220 Lens controller
400 Display bar
401 First indicator
402 Second indicator
600 Housing
601, 602 Display panel
604 Liquid crystal panel
605 Viewfinder
610 Lens barrel
612 Display panel
700 Smartphone
702 Screen
1200 Computer
1210 Host controller
1212 Central processing unit (CPU)
1214 Random-access memory (RAM)
1220 Input/Output (I/O) controller
1222 Communication interface
1230 Read-only memory (ROM)

### DETAILED DESCRIPTION OF THE EMBODIMENTS

The present disclosure is described through embodiments, but following embodiments do not limit the present disclosure. Those of ordinary skill in the art can make various modifications or improvements to following embodiments. Such modifications or improvements are within the scope of the present disclosure.

Various embodiments of the present disclosure are described with reference to flowcharts or block diagrams. In this disclosure, a block in the figures can represent (1) an execution stage of a process of operation or (2) a functional unit of a device for operation execution. The referred stage or unit can be implemented by a programmable circuit and/or a processor. A special-purpose circuit may include a digital and/or analog hardware circuit or may include an integrated circuit (IC) and/or a discrete circuit. The programmable circuit may include a reconfigurable hardware circuit. The reconfigurable hardware circuit may include logical AND, logical OR, logical XOR, logical NAND, logical NOR, other logical operation circuits, a trigger, a register, a field-programmable gate arrays (FPGA), a programmable logic array (PLA), or another storage device.

A computer-readable medium may include any tangible device that can store commands executable by an appropriate device. The commands, stored in the computer-readable medium, can be executed to perform operations consistent with the disclosure, such as those specified according to the flowchart or the block diagram described below. The computer-readable medium may include an electronic storage medium, a magnetic storage medium, an optical storage medium, an electromagnetic storage medium, a semiconductor storage medium, etc. The computer-readable medium may include a Floppy Disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray (RTM) disc, memory stick, integrated circuit card, etc.

A computer-readable command may include any one of source code or object code described by any combination of one or more programming languages. The source or object codes include traditional procedural programming languages. The traditional procedural programming languages can be assembly commands, command set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing device. The processor or the programmable circuit can execute computer-readable commands to be a manner for performing the operations specified in the flowchart or block diagram. The example of the processor includes a computer processor, a processing unit, a microprocessor, a digital signal processor, a controller, a microcontroller, etc.

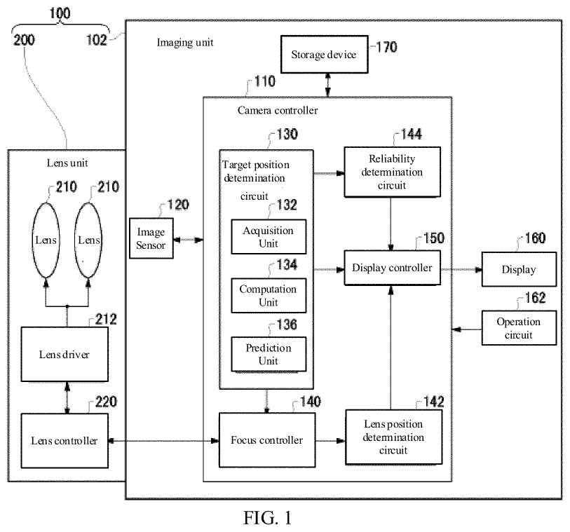

FIG. 1 is a schematic diagram showing functional blocks of a camera device 100 according to some embodiments of the present disclosure. The camera device 100 includes an imaging unit 102 and a lens unit 200. The imaging unit 102 includes an image sensor 120, a camera controller 110, a storage device 170, a display 160, and an operation circuit 162. The image sensor 120 may be composed of a charge-coupled device (CCD) or a complementary metal-oxide-semiconductor (CMOS). The image sensor 120 may convert an optical image photographed by a plurality of lenses 210 into an electrical signal. The image sensor 120 may transmit image data of the optical image photographed by the plurality of lenses 210 to the camera controller 110. The camera controller 110 may be composed of a microprocessor such as a central processing unit (CPU), a micro processing unit (MPU), etc., or a microcontroller such as a microcontroller unit (MCU). The camera controller 110 can control the camera device 100 according to operation commands from the operation circuit 162. The storage device 170 may include a computer-readable storage medium and may include at least one of SRAM, DRAM, EPROM, EEPROM, or a USB flash drive. The storage device 170 stores programs required for the camera controller 110 to control the image sensor 120. The storage device 170 may be placed in a housing of the camera device 100. The storage device 170 may be detachably arranged inside a housing of the camera device 100. The display 160 may display the image data output from the image sensor 120. The display 160 may display various setting information of the camera device 100. The display 160 may include a liquid crystal display (LCD), a touch panel display, etc. The display 160 may include a plurality of LCDs or touch panel displays.

The lens unit 200 includes the plurality of lenses 210, a plurality of lens drivers 212, and a lens controller 220. The plurality of lenses 210 may function as a zoom lens, a varifocal lens, and a focus lens. At least some or all of the plurality of lenses 210 are configured to move along an optical axis. The lens unit 200 may be an interchangeable lens arranged to be detachable from the imaging unit 102. The lens driver 212 causes at least some or all of the plurality of lenses 210 to move along the optical axis. The lens controller 220 drives the lens driver 212 according to lens control commands from the imaging unit 102 to cause one or the plurality of lenses 210 to move along the optical axis. The lens control commands are, for example, zoom control commands and focus control commands.

The camera device 100 may perform autofocus (AF) processing and photographing of the desired object.

To perform the AF processing, the camera device 100 may determine a distance from the lens to the object being photographed (also referred to as “distance to the object being photographed”). In this disclosure, the object being photographed is also referred to as a “target object” and the distance to the object being photographed is also referred to as a “target distance.” A method of determining the target distance includes determining the target distance based on costs of a plurality of images photographed under different states of position relationship between the lens and an imaging plane. This method is referred to as bokeh detection autofocus (BDAF) method.

For example, cost of an image is represented using a Gaussian function shown in formula (1) below. In formula (1), x denotes a pixel position in a horizontal direction, and a denotes a standard deviation.

$$C ( x , σ ) = \frac{1}{\sqrt{2 π}} exp ( - \frac{{x}^{2}}{2 {σ}^{2}} ) \qquad ( 1 )$$

FIG. 2 shows an example of a curve 500 of formula (1). The focus point may be focused on an object in an image I by focusing a focus lens at a lens position corresponding to a lowest point 502 of the curve 500.

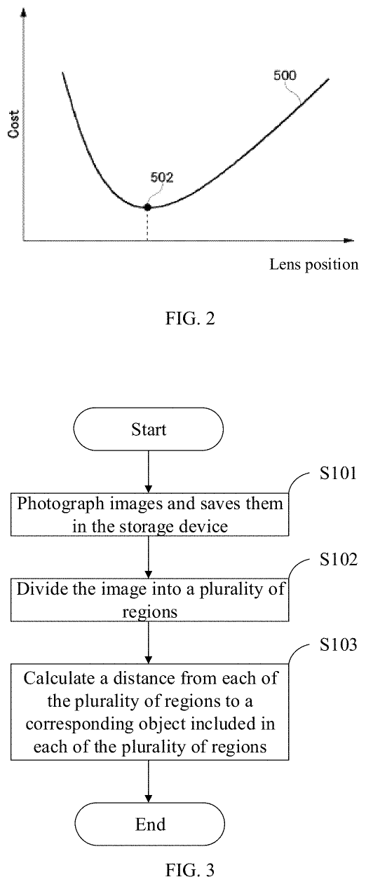

FIG. 3 is a schematic flowchart showing a process of calculating a distance using the BDAF method. First, when the lens and the imaging plane is in a first position-relationship state, the camera device 100 photographs a first image I1 and saves it in a storage device 170. Then, through movement of the focus lens or the imaging plane of the image sensor 120 along an optical axis, the lens and the imaging plane are caused to be in a second position relationship. The camera device 100 photographs a second image I2 and saves it in the storage device 170 (S101). For example, for a mountain-climbing AF method, the focus lens or the imaging plane of the image sensor 120 may be caused to move along the optical axis but not beyond the focus point. A movement amount of the focus lens or the imaging plane of the image sensor 120 may be, for example, 10 μm.

Subsequently, the camera device 100 divides the image I1 into a plurality of regions (S102). A feature amount may be calculated for each pixel in the image I1. Then, the image I1 may be divided into the plurality of regions with each region including a group of pixels having similar feature amounts. The pixel groups having determined ranges of the AF processing frames in the image I1 are divided into a plurality of regions. The camera device 100 may divide the image I2 into a plurality of regions corresponding to the plurality of regions of the image I1. The camera device 100 calculate, for each of the plurality of regions, a distance to a corresponding object included in the region based on the cost of the corresponding region of the image I1 and the cost of the corresponding region of the image I2 (S103).

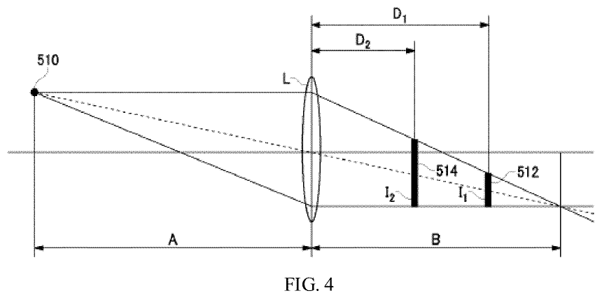

Referring to FIG. 4, a distance calculation process is further described. Let a distance from a lens L (principal point) to an object 510 (object plane) be A, a distance from the lens L (principal point) to a position (image plane) of the object 510 imaging on the imaging plane be B, and a focal length be F. In this case, the relationship among the distance A, distance B, and the focal length F may be described according to formula (2) below, i.e., the lens formula.

$$\frac{1}{A} + \frac{1}{B} = \frac{1}{F} \qquad ( 2 )$$

The focus distance is determined by the lens position. Thus, if the distance B of the target object 510 imaged on the imaging plane may be determined, the distance A from the lens L to the target object 510 may be determined by using formula (2).

As shown in FIG. 4, the distance B may be determined by calculating the image position of the target object 510 based on a size of a blur (diffusion circle 512 or 514) of the target object 510 projected on the imaging plane, and then the distance A can be determined. That is, the image position may be determined utilizing the fact that the size of the blur (cost) is proportional to the imaging plane and the imaging position.

Let the distance from the image I1 closer to the imaging plane to the lens L be D1. Let the distance from the image I2 farther from the imaging plane to the lens L be D2. Each of the images may be blurry, i.e., have blur. Let a point spread function be PSF. Let the images at D1 and D2 be Id1 and Id2, respectively. In this case, for example, the image I1 can be expressed by formula (3) below according to the convolution operation.

I₁=PSF*I_{d1} (3)

Here, let the Fourier transform function of the image data Id1 and Id2 be f. Let optical transfer functions obtained by performing the Fourier transformation on the point spread functions of the image Id1 and Id2 be OTF1 and OTF2. The formula is shown below.

$$\frac{O T {F}_{2} \cdot f}{O T {F}_{1} \cdot f} = \frac{O T {F}_{2}}{O T {F}_{1}} = C \qquad ( 4 )$$

In formula (4), C denotes a change amount of the cost between the image Id1 and Id2. That is, C is a difference between the cost of the image Id1 and the cost of the image Id2.

However, when moving the focus lens manually to cause the focus point to be focused at the target object, a user may not be able to control how to adjust the lens position of the focus lens.

Therefore, with the camera device 100 of embodiments of the present disclosure, the user may easily control how to adjust the lens position of the focus lens to focus on the desired object.

In the camera device 100 as shown in FIG. 1, the camera controller 110 includes a target position determination circuit 130, a focus controller 140, a lens position determination circuit 142, a reliability determination circuit 144, and a display controller 150.

The lens position determination circuit 142 may be configured to determine a lens position of a focus lens of the camera device 100. The lens position determination circuit 142 may determine a present lens position of the focus lens. The lens position determination circuit 142 may be an example of a first determination circuit.

The target position determination circuit 130 may be configured to determine the position of the target object photographed by the camera device 100. In this disclosure, the position of the target object is also referred to as a “target position.” The target position determination circuit 130 may determine a distance A from the lens L (principle point) to the target object 510 (object plane) shown in FIG. 3 as the target position of the target object. The focus controller 140 may be configured to focus at the target object by moving the focus lens to the lens position corresponding to the target position.

The target position determination circuit 130 may calculate the image position of the target object based on the cost amounts of the plurality of images photographed under different states of the position relationship between the imaging plane and the focus lens, so as to determine the distance B. The target position determination circuit 130 may then determine the target position by determining the distance A. The target position determination circuit 130 may be an example of a second determination circuit.

The target position determination circuit 130 includes an acquisition circuit 132, a computation circuit 134, and an prediction circuit 136. The acquisition circuit 132 may be configured to obtain a first image and a second image. The first image may be included in a first photographed image photographed when the imaging plane and the focus lens are in the first position relationship. The second image may be included in a second photographed image photographed when the imaging plane and the focus lens are in the second position relationship. The computation circuit 134 may be configured to calculate the cost of each of the first image and the second image. The prediction circuit 136 may be configured to predict the target position based on the cost of each of the first image and the second image. The prediction circuit 136 may calculate the image position of the target object based on the cost of each of the first image and the second image to determine the distance B, and further determine the distance A to predict the target position.

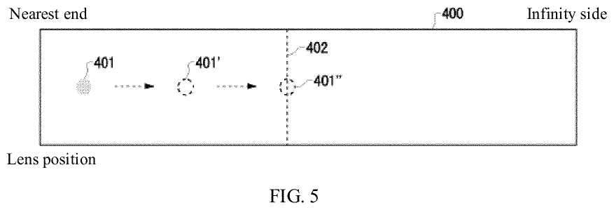

According to the position relationship corresponding to the relationship between the lens position and the target position, the display controller 150 may display a first indicator 401 indicating the lens position and a second indicator 402 indicating the target position on the display 160. The display controller 150 may display the first indicator 401 indicating the lens position and the second indicator 402 indicating the target position of a desired target object on a display bar 400 shown in FIG. 5 according to the position relationship corresponding to the relationship between the lens position and the target position. The display controller 150 may display the relationship between the first indicator 401 and the second indicator 402 on the display 160 according to the position relationship of absolute positions.

The desired target object may include a target object in a predetermined region, such as a central region of an image photographed by the camera device 100, or a target object in a region selected by the user from the image.

The display controller 150 may display the first indicator 401 and the second indicator 402 on the display 160 in a manner that the first indicator 401 moves along a length direction of the display bar 400 relative to the second indicator 402 according to the change of the lens position of the focus lens. The display controller 150 may display the first indicator 401 on the display bar 400 in a manner that the first indicator 401 moves along the length direction of the display bar 400 according to the movement of the focus lens. The length direction of the display bar 400 is an example of a first direction. For example, when the focus lens moves from a nearest side to an infinity side, the display controller 150 may display the first indicator 401 on the display unit 160 in a manner of gradually moving along the length direction of the display bar 400 shown as the first indicator 401, the first indicator 401′, and the first indicator 401″ in the figure.

The second indicator 402 indicates the target position of the desired target object, and also indicates the lens position of the focus lens for focusing on the desired target object. If the desired target object has a same distance to the camera device 100, that is, the desired target object does not move relative to the camera device 100, the display controller 150 displays the second indicator 402 at the same position on the display bar 400.

When the first indicator 401 overlaps with the second indicator 402, the focus lens is at a position of a lens that focuses on the desired target object. For example, when the first indicator 401 is moved to a position of the first indicator 401′ by moving the focus lens, the focus lens may focus on the desired target object.

The display bar 400 shown in FIG. 5 may be configured to indicate the lens position of the focus lens and a distance from the camera device 100 to the target object and may be used as a scale in the length direction. That is, the first indicator 401 on the display bar 400 may indicate the portion of the region between a lens position corresponding to the lens being focused on the nearest end to a lens position corresponding to the lens being focused on the infinity, in which the present lens position of the focus lens is located. The second indicator 402 on the display bar 400 may indicate an predicted lens position for focusing on the desired target object.

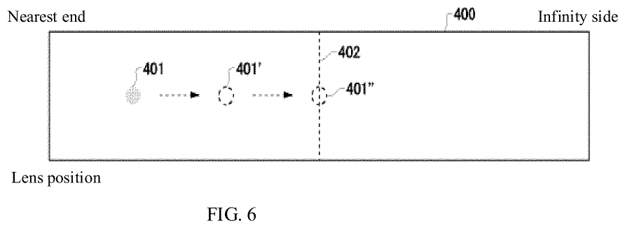

As shown in FIG. 6, the display controller 150 may display the relationship between the first indicator 401 and the second indicator 402 on the display 160 with the position relationship of relative positions. The display controller 150 may display the first indicator 401 and the second indicator 402 on the display 160 with an interval corresponding to a difference between the lens position of the focus lens and the lens position of the focus lens focused on the target position. The display controller 150 may display the second indicator 402 on the display 160 in a manner that no matter where the target position of the desired target object is, the second indicator 402 is displayed in the center of the display bar 400. The display controller 150 may display the first indicator 401 and the second indicator 402 on the display 160 in a manner that when a distance of the lens position of the focus lens is closer to the lens position corresponding to the target position of the desired target object, the interval between the first indicator 401 and the second indicator 402 is smaller.

The reliability determination circuit 144 may be configured to determine the reliability of the target position of the target object determined by the target position determination circuit 130. The reliability determination circuit 144 may determine the reliability of the target position, such that the prediction accuracy of the target position determined by the target position determination circuit 130 is higher, the reliability is higher. The reliability determination circuit 144 may determine the reliability of the target position based on the cost of the target object of the image photographed by the camera device 100. For example, the reliability determination circuit 144 may determine the reliability of the target position based on the cost of the image calculated based on formula (1) that uses the Gaussian function. When the camera device includes a ranging sensor having a ranging function that can, e.g., measure the distance of the target object with a relatively high accuracy, the reliability determination circuit 144 may determine the reliability indicating a predetermined largest value as the reliability of the target position of the target object. In this case, the reliability of the target position of the target object is always constant. The display controller 150 may display the first indicator 401 or the second indicator 402 on the display 160 in a size corresponding to the reliability. The display controller 150 may display the width of the second indicator 402 in a width direction of the display bar 400 on the display 160 with a width corresponding to the reliability. The width direction of the display bar 400 may be an example of a second direction.

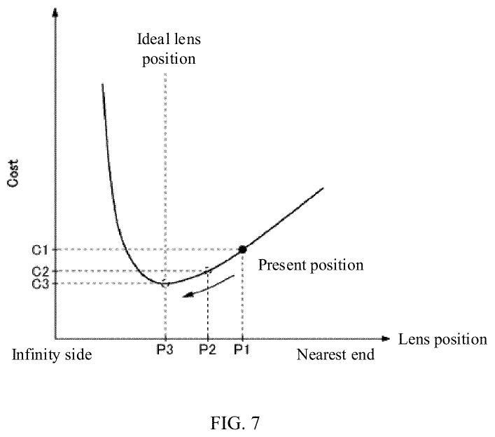

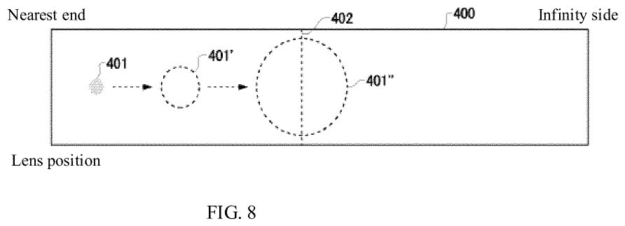

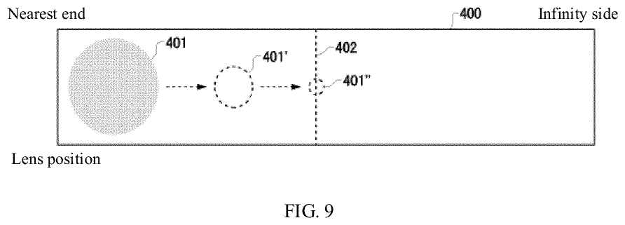

For example, as shown in FIG. 7, the focus lens moves from a lens position P1 at the nearest end side to a lens position P2 and then moves to a lens position P3. The lens position P3 is an ideal lens position for focusing on the desired target object. In this case, the cost changes from cost C1 to cost C2 and then to cost C3. A smaller cost represents a higher prediction accuracy of the target position. The display controller 150 may display the first indicator 401 or the second indicator 402 on the display 160 in a size corresponding to the cost. For example, as shown in FIG. 8, the display controller 150 displays the first indicator 401 on the display 160 in a manner that the higher is the reliability, the larger is the first indicator 401. The closer is the lens position of the focus lens to the ideal lens position corresponding to the lens being focused on the desired target object, the higher is the reliability of the target position. Therefore, the display controller 150 may display the first indicator 401 on the display 160 in a manner that the closer is the lens position of the focus lens to the ideal lens position, the larger is the first indicator 401. In another example, as shown in FIG. 9, the display controller 150 displays the first indicator 401 on the display 160 in a manner that the higher is the reliability, the smaller is the first indicator 401.

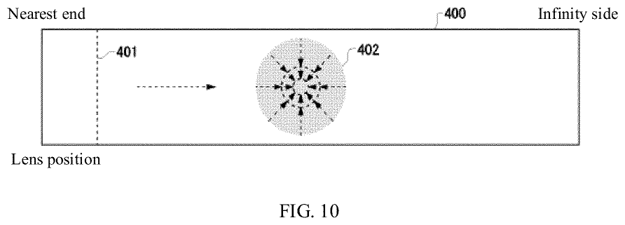

The display controller 150 may display the second indicator 402 on the display 160 in a size corresponding to the reliability. As shown in FIG. 10, the display controller 150 displays the second indicator 402 on the display 160 in a manner that the higher is the reliability of the target position, the larger is the size of the second indicator 402. The display controller 150 may display the first indicator 401 on the display 160 in a manner that the closer is the focus lens to the ideal lens position corresponding to the lens being focused on the desired target object, the closer is the first indicator 401 indicating the lens position of the focus lens to the second indicator 402 indicating the ideal lens position (target position). The display controller 150 may display the second indicator 402 on the display 160 in a manner that that the higher is the reliability of the target position, the larger is the size of the second indicator 402.

The target position determination circuit 130 may determine a range of the target position of the target object. The display controller 150 may display the width of the second indicator 402 in a length direction of the display bar 400 with a width corresponding to the range of the target position. The larger is the difference between the ideal lens position and the present lens position, the lower is the accuracy of the target position determined by the target position determination circuit 130 based on the cost of the image. That is, the larger is the difference between the ideal lens position and the present lens position, the wider is the prediction of the lens position corresponding to the focus lens being focused on the desired target object. The display controller 150 may display the second indicator on the display 160 by considering this width. The display controller 150 may display the width of the second indicator 402 in the width direction of the display bar 400 on the display 160 with the width corresponding to the reliability.

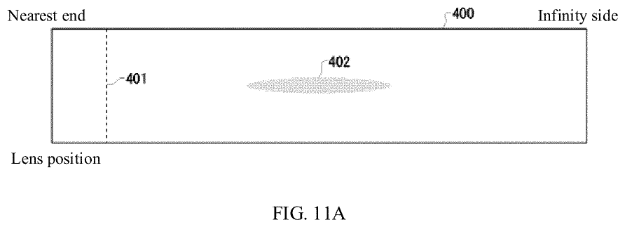

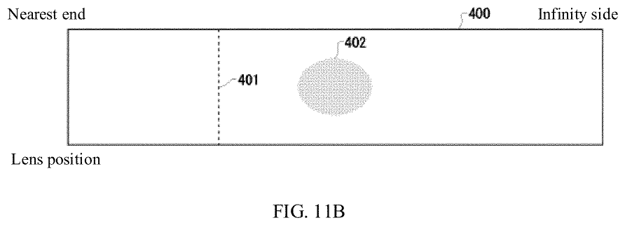

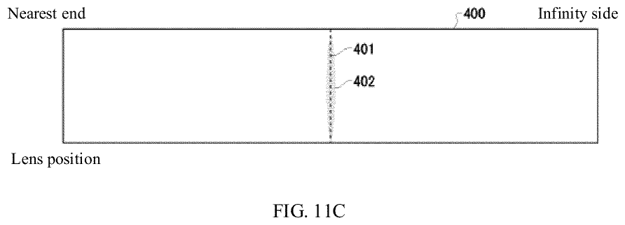

As shown in FIGS. 11A, 11B, and 11C, the display controller 150 displays the second indicator 402 on the display 160 in a manner that the larger is the distance between the lens position of the focus lens and the ideal lens position corresponding to the target position, the longer is the length of the second indicator 402 in the length direction of the display bar 400, and the smaller is the width of the second indicator 402 in the width direction of the display bar 400. As shown in FIGS. 11A, 11B, and 11C, the closer is the lens position of the focus lens to the ideal lens position corresponding to the target position, the higher is the accuracy of the target position, and the narrower is the range of the target position.

The target position determination circuit 130 may determine a plurality of target object positions of a plurality of target objects photographed by the camera device 100. The display controller 150 may display the second indicators indicating the plurality of target positions on the display 160 according to the position relationship corresponding to the relationships between the lens position of the focus lens and the plurality of target positions.

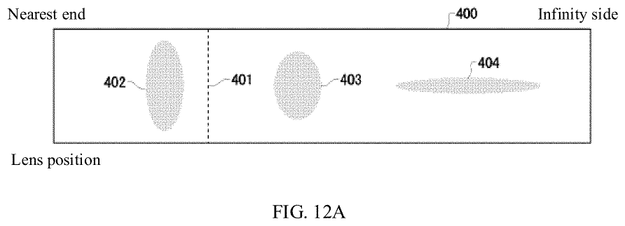

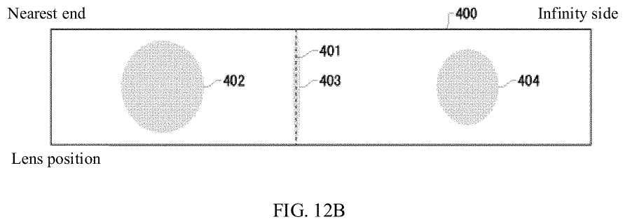

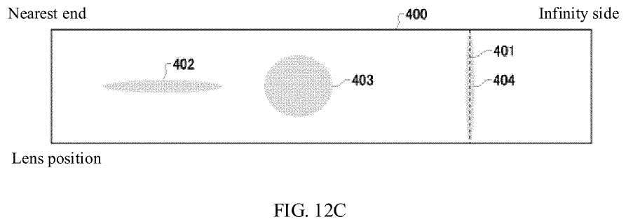

FIG. 12A, FIG. 12B, and FIG. 12C show examples of displaying the second indicators 402, 403, and 404 of three target objects on the display bar 400. The display controller 150 may display the second indicators 402, 403, and 404 on the display 160 in a manner that the smaller is the difference between the lens position of the focus lens and the ideal lens position of the target position, the longer is the length of the second indicator in the length direction of the display bar 400, and the wider is the width of the second indicator in the width direction of the display bar 400.

In some embodiments, the display controller 150 may display the first indicator indicating the lens position and the second indicator indicating the target position on the display 160 according to the position relationship corresponding to the relationship between the lens position and the target position. As such, the user can know how to adjust the lens position of the focus lens to focus on the desired target object. The user may determine the position relationship between the first indicator indicating the lens position and the second indicator indicating the target position through the display 160. As such, the user can know in which direction (toward the nearest end or the infinity side) and for how much to move the focus lens.

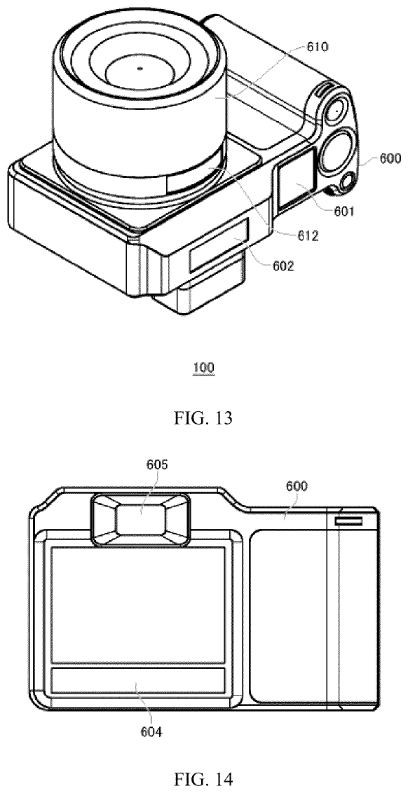

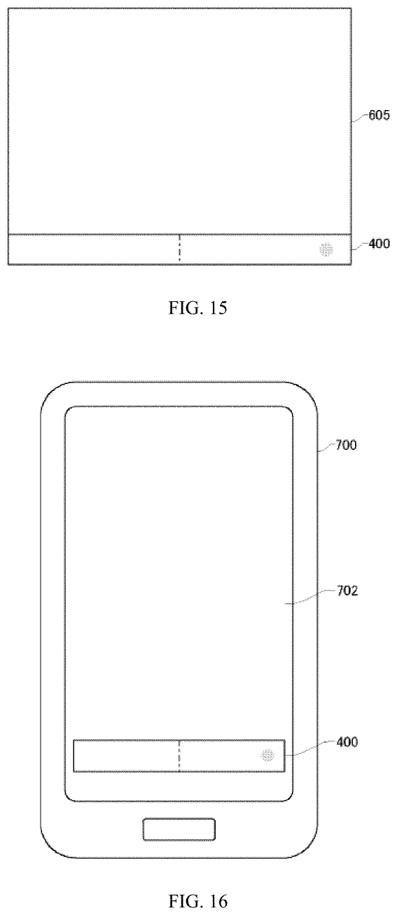

FIG. 13 shows an exemplary diagram of a 3D outer appearance of the camera device 100 according to some embodiments of the present disclosure. FIG. 14 shows an exemplary diagram of a rear view of the camera device according to some embodiments of the present disclosure. For example, the display bar 400 may be displayed on a display panel 601 or display panel 602 placed on the external surface of the housing 600. The display bar 400 may be displayed on a display panel 612 on a peripheral surface of lens barrel 610. The display bar 400 may be displayed on the liquid crystal panel 604 on a back surface of the housing 600 of the camera device 100. The display bar 400 may be displayed in the viewfinder 605 of the camera device 100. For example, as shown in FIG. 15, the display bar 400 is displayed at a lower portion of the viewfinder 605.

As shown in FIG. 16, the display bar 400 is displayed on a screen 702 of a smartphone 700 having a photographing function.

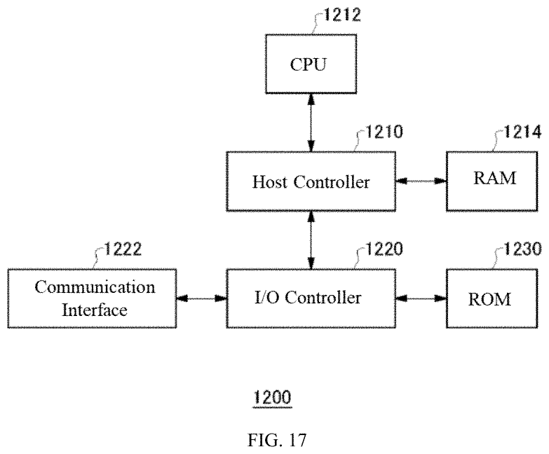

FIG. 17 shows an example of a computer 1200 representing all or some aspects of the present disclosure. Programs installed on the computer 1200 can cause the computer 1200 to function as a device or one or more units of the device according to embodiments of the present disclosure. In some embodiments, the program can cause the computer 1200 to implement the operation or one or more units. The program may cause the computer 1200 to implement a process or a stage of the process according to embodiments of the present disclosure. The program may be executed by a CPU 1212 to cause the computer 1200 to implement a specified operation associated with some or all blocks in the flowchart and block diagram described in the present specification.

In some embodiments, the computer 1200 includes the CPU 1212 and a RAM 1214. The CPU 1212 and the RAM 1214 are connected to each other through a host controller 1210. The computer 1200 further includes a communication interface 1222, and an I/O unit. The communication interface 1222 and the I/O unit are connected to the host controller 1210 through an I/O controller 1220. The computer 1200 further includes a ROM 1230. The CPU 1212 operates according to programs stored in the ROM 1230 and the RAM 1214 to control each of the units.

The communication interface 1222 communicates with other electronic devices through networks. A hardware driver may store the programs and data used by the CPU 1212 of the computer 1200. The ROM 1230 stores a boot program executed by the computer 1200 during operation, and/or the program dependent on the hardware of the computer 1200. The program is provided through a computer-readable storage medium such as CR-ROM, a USB storage drive, or IC card, or networks. The program is installed in the RAM 1214 or the ROM 1230, which can also be used as examples of the computer-readable storage medium, and is executed by the CPU 1212. Information processing described in the program is read by the computer 1200 to cause cooperation between the program and the above-mentioned various types of hardware resources. The computer 1200 implements information operations or processes to constitute the device or method.

For example, when the computer 1200 communicates with external devices, the CPU 1212 can execute a communication program loaded in the RAM 1214 and command the communication interface 1222 to process the communication based on the processes described in the communication program. The CPU 1212 controls the communication interface 1222 to read transmission data in a transmitting buffer provided by a storage medium such as the RAM 1214 or the USB storage drive and transmit the read transmission data to the networks, or write data received from the networks in a receiving buffer provided by the storage medium.

The CPU 1212 can cause the RAM 1214 to read all or needed portions of files or databases stored in an external storage medium such as a USB storage drive, and perform various types of processing to the data of the RAM 1214. Then, the CPU 1212 can write the processed data back to the external storage medium.

The CPU 1212 can store various types of information such as various types of programs, data, tables, and databases in the storage medium and process the information. For the data read from the RAM 1214, the CPU 1212 can perform the various types of processes described in the present disclosure, including various types of operations, information processing, condition judgment, conditional transfer, unconditional transfer, information retrieval/replacement, etc., specified by a command sequence of the program, and write the result back to the RAM 1214. In addition, the CPU 1212 can retrieve information in files, databases, etc., in the storage medium. For example, when the CPU 1212 stores a plurality of entries having attribute values of a first attribute associated with attribute values of a second attribute in the storage medium, the CPU 1212 can retrieve an attribute from the plurality of entries matching a condition specifying the attribute value of the first attribute, and read the attribute value of the second attribute stored in the entry. As such, the CPU 1212 obtains the attribute value of the second attribute associated with the first attribute that meets the predetermined condition.

The above-described programs or software modules may be stored on the computer 1200 or in the computer-readable storage medium near the computer 1200. The storage medium such as a hard disk drive or RAM provided in a server system connected to a dedicated communication network or Internet can be used as a computer-readable storage medium. Thus, the program can be provided to the computer 1200 through the networks.

An execution order of various processing such as actions, sequences, processes, and stages in the devices, systems, programs, and methods shown in the claims, the specifications, and the drawings, can be any order, unless otherwise specifically indicated by “before,” “in advance,” etc., and as long as an output of previous processing is not used in subsequent processing. Operation procedures in the claims, the specifications, and the drawings are described using “first,” “next,” etc., for convenience. However, it does not mean that the operating procedures must be implemented in this order.

The present disclosure is described above with reference to embodiments, but the technical scope of the present disclosure is not limited to the scope described in the above embodiments. For those skilled in the art, various changes or improvements can be made to the above-described embodiments. It is apparent that such changes or improvements are within the technical scope of the present disclosure.

What is claimed is:

1. A display control device comprising:
a processor;
a computer-readable storage medium storing a program that, when executed by the processor, causes the processor to:
determine a present lens position of a lens of a camera device;
determine a target position of a target object being photographed by the camera device; and
display a first indicator indicating the present lens position and a second indicator indicating the target position on a display in a position relationship corresponding to a relationship between the present lens position and the target position.

2. The device of claim 1, wherein the program further causes the processor to:
display the first indicator on the display in a manner that the first indicator moves along a direction relative to the second indicator according to a change of the present lens position.

3. The device of claim 2, wherein the program further causes the processor to:
determine a range of the target position; and
display the second indicator on the display with a width in the direction corresponding to the range of the target position.

4. The device of claim 3, wherein the program further causes the processor to:
determine the range of the target position according to the change of the present lens position.

5. The device of claim 3, wherein:
the direction is a first direction; and
the program further causes the processor to:
determine a reliability of the target position; and
display the second indicator on the display with a width in a second direction corresponding to the reliability.

6. The device of claim 5, wherein the program further causes the processor to:
determine the reliability of the target position according to the change of the present lens position.

7. The device of claim 5, wherein the program further causes the processor to:
determine the reliability of the target position based on a cost of the target object in an image photographed by the camera device.

8. The device of claim 3, wherein the program further causes the processor to:
determine a reliability of the target position; and
display the first indicator or the second indicator on the display with a size corresponding to the reliability.

9. The device of claim 8, wherein the program further causes the processor to:
determine the reliability of the target position according to the change of the present lens position.

10. The device of claim 8, wherein the program further causes the processor to:
determine the reliability of the target position based on a cost of the target object in an image photographed by the camera device.

11. The device of claim 10, wherein the target object is selected in the image photographed by the camera device.

12. The device of claim 10, wherein the target object is included in a predetermined region in the image photographed by the camera device.

13. The device of claim 1, wherein the program further causes the processor to:
display the first indicator and the second indicator on the display with an interval corresponding to a difference between the present lens position and an ideal lens position corresponding to the lens being focused on the target position.

14. The device of claim 13, wherein the program further causes the processor to:
display the first indicator and the second indicator on the display in a manner that the first indicator moves relative to the second indicator according to a change of the difference.

15. The device of claim 1, wherein the program further causes the processor to:
obtain a first image photographed when an imaging plane of the camera device and the lens are in a first position relationship;
obtain a second image photographed when the imaging plane and the lens are in a second position relationship;
calculate a cost of the first image and a cost of the second image; and
predict the target position based on the cost of the first image and the cost of the second image.

16. The device of claim 15, wherein the cost of first image and the cost of the second image are associated with blurry of an image.

17. The device of claim 15, wherein the program further causes the processor to:
calculate the cost of first image and the cost of the second image based on a point spread function.

18. The device of claim 1, wherein:
the target object is one of a plurality of target objects being photographed by the camera device; and
the program further causes the processor to:
determine a plurality of target positions of the plurality of target objects; and
display a plurality of second indicators on the display to indicate the plurality of target positions in position relationships corresponding to relationships between the present lens position and the plurality of target positions.

19. The device of claim 1, wherein the display is a smartphone.

20. A camera device comprising:
a lens;
an image sensor configured to convert an optical image formed through the lens into an electrical signal;
a display; and
a display control device including:
a processor;
a computer-readable storage medium storing a program that, when executed by the processor, causes the processor to:
determine a present lens position of the lens;
determine a target position of a target object being photographed by the camera device; and
display a first indicator indicating the present lens position and a second indicator indicating the target position on a display in a position relationship corresponding to a relationship between the present lens position and the target position.
